(19) United States
(12) Patent Application Publication
(10) Pub. No.: US 2005/0142952 A1
(43) Pub. Date: Jun. 30, 2005

(54) Printed circuit board jack

(76) Inventor: Yuan-Huei Peng, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(21) Appl. No.: 10/997,186

(22) Filed: Nov. 24, 2004

(30) Foreign Application Priority Data
Dec. 26, 2003 (TW) 092222801

(51) Int. Cl. H01R 24/00

(52) U.S. Cl. 439/676

(57) ABSTRACT

An improved PCB jack for eliminating the electromagnetic interference formed therein is provided. The Printed Circuit Board jack (PCB jack) includes a jack body for being connected to a plug, a first wire having a first portion for transmitting a first signal, a second wire having a second portion for transmitting a second signal, a first conducting piece connected to the first portion of the first wire and a second conducting piece connected to the second portion of the second wire. The electromagnetic interference formed between the first wire and the second wire is eliminated.

### FIELD OF THE INVENTION

This invention mainly relates to a network jack for eliminating the electromagnetic interference therein. And more particularly to a Printed Circuit Board jack (PCB jack) for eliminating the electromagnetic interference therein.

### BACKGROUND OF THE INVENTION

Generally, a network plug for a communication system is usually connected to a metal wire holder and the metal wire holder could be located inside a PCB jack or could be mounted on a panel. Please refer to FIGS. 1-3, which are diagrams respectively showing the configurations of a panel, a PCB jack and a metal wire holder according to the prior art. As shown in FIG. 1, six PCB jacks 10 are placed on the Panel 11, and the metal wire holder 12 inside the PCB jack 10 can be replaced as a metal wire holder 20 showed in FIG. 2. Both metal wire holders 12 and 20 could be used for being connected with the network plug (not shown). The metal wire holder 20 has eight pins 21 thereon, and the eight pins 21 will further form four wire sets 31, 32, 33 and 34 showed in FIG. 3. As shown in FIG. 3, since the first wire set 31 and the second wire set 32 are adjacent to each other, the distance therebetween is not enough to eliminate the electromagnetically induced phases generated while signals are transmitted therethrough. Therefore, the cross talk phenomenon would occur therein unavoidably and further interfere the signal transmission.

Based on the above, in order to overcome the drawbacks in the prior art, an improved PCB jack are provided in the present invention for eliminating the cross talk generated from the transmission of the first and second signals and also for assuring the stability and reliability of the signal transmission.

### SUMMARY OF THE INVENTION

In one respect of the present invention, a PCB jack for eliminating an electromagnetic interference formed therein is provided. The PCB jack includes a jack body for being connected to a plug, a first wire configured inside the jack body and having a first portion for transmitting a first signal, a second wire configured inside the jack body and having a second portion for transmitting a second signal, a first conducting piece connected to the first portion of the first wire and a second conducting piece connected to the second portion of the second wire, wherein the electromagnetic interference formed between the first wire and the second wire is eliminated.

Preferably, the first wire has a first engaging endpoint for being electrically connected to a blue wire of the plug, and the first conducting piece is an L-shaped copper sheet having a first capacitor area and a first connecting area.

Preferably, the first connecting area of the first conducting piece has a first connecting surface for being connected to the first portion of the first wire, and the first capacitor area has a first extending surface for eliminating the electromagnetic interference.

Preferably, the second wire has a second engaging endpoint for being electrically connected to a green wire of the plug, and the second conducting piece is an L-shaped copper sheet having a second capacitor area and a second connecting area.

Preferably, the second connecting area of the second conducting piece has a second connecting surface for being connected to the second portion of the second wire, and the second capacitor area has a second extending surface for eliminating the electromagnetic interference.

Preferably, the PCB jack further includes a third and a fourth wires for being connected to an orange and a brown wires of the plug for transmitting a third and a fourth signals respectively.

In another aspect of the present invention, a PCB jack is provided. The PCB jack includes a jack body for being connected to a plug, a first wire configured inside the jack body for transmitting a first signal, and a first conducting piece connected to the first wire for eliminating a first cross-talk generated upon transmitting the first signal.

Preferably, the PCB jack is used for eliminating an electromagnetic interference formed therein, wherein the first wire has a first portion. The PCB jack includes a second wire configured inside the jack body, wherein the second wire has a second portion for transmitting a second signal, and further includes a second conducting piece connected to the second portion of the second wire for eliminating a second cross talk generated upon transmitting the second signal.

Preferably, the first wire has a first engaging endpoint for being electrically connected to a blue wire of the plug, and the first conducting piece is an L-shaped copper sheet having a first capacitor area and a first connecting area.

Preferably, the first connecting area of the first conducting piece has a first connecting surface for being connected to the first portion of the first wire, and the first capacitor area has a first extending surface for eliminating the first cross talk.

Preferably, the second wire has a second engaging endpoint for being electrically connected to a green wire of the plug, and the second conducting piece is an L-shaped copper sheet having a second capacitor area and a second connecting area.

Preferably, the second connecting area of the second conducting piece has a second connecting surface for being connected to the second portion of the second wire, and the second capacitor area has a second extending surface for eliminating the second cross talk.

Preferably, the PCB jack further includes a third and a fourth wires for being connected to an orange and a brown wires of the plug for transmitting a third and a fourth signals respectively.

In another aspect of the present invention, a PCB jack is provided. The PCB jack includes a first wire having a first portion for transmitting a first signal, a second wire having a second portion for transmitting a second signal, a first conducting piece connected to the first portion of the first wire for eliminating a first cross-talk generated upon transmitting the first signal, and a second conducting piece connected to the second portion of the second wire for eliminating a second cross talk generated upon transmitting the second signal.

Preferably, the PCB jack is used for eliminating an electromagnetic interference formed therein, and further includes a jack body for being connected to a plug, wherein the first wire and the second wire are configured inside the jack body.

Preferably, the first wire has a first engaging endpoint for being electrically connected to a blue wire of the plug, and the first conducting piece is an L-shaped copper sheet having a first capacitor area and a first connecting area.

Preferably, the first connecting area of the first conducting piece has a first connecting surface for being connected to the first portion of the first wire, and the first capacitor area has a first extending surface for eliminating the first cross talk.

Preferably, the jack body has a first and a second slots for respectively containing therein the first connecting area of the first conducting piece and the second connecting area of the second conducting piece.

Preferably, the jack body has a first and a second props for propping the first and the second conducting piece.

Preferably, the first and the second wires are configured inside a holder, wherein the holder has a protruding tenon for engaging a third slot of the jack body.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a front view illustrating a panel and a PCB jack thereon according to the prior art;

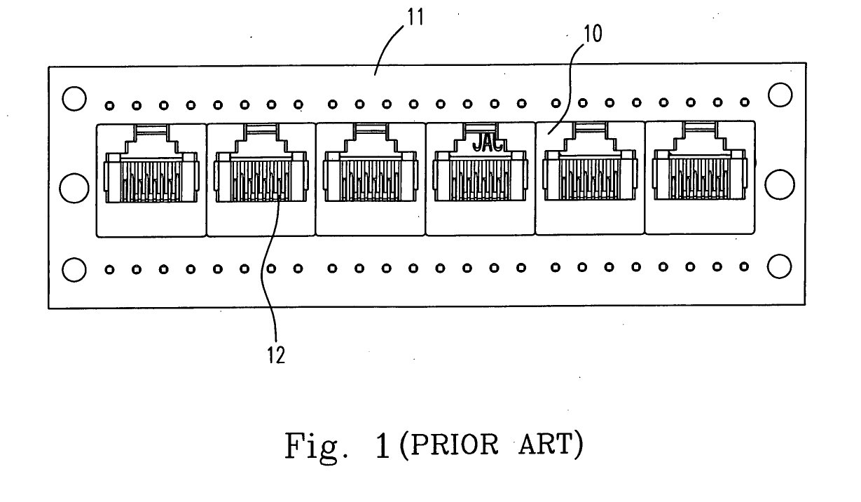

FIG. 2 is a stereo perspective view illustrating a metal wire holder for a PCB jack according to the prior art;

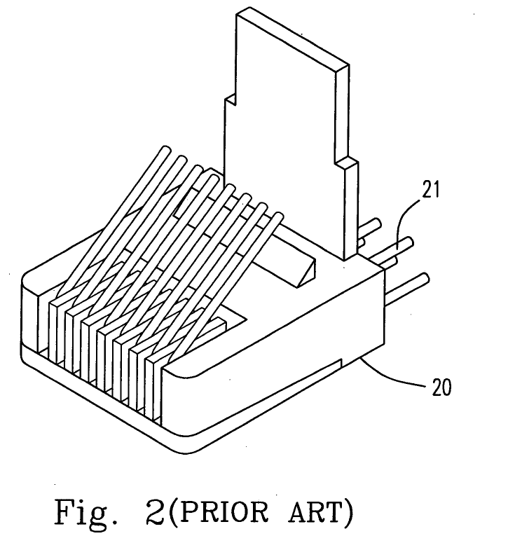

FIG. 3 is a stereo perspective view illustrating a PCB jack according to the prior art

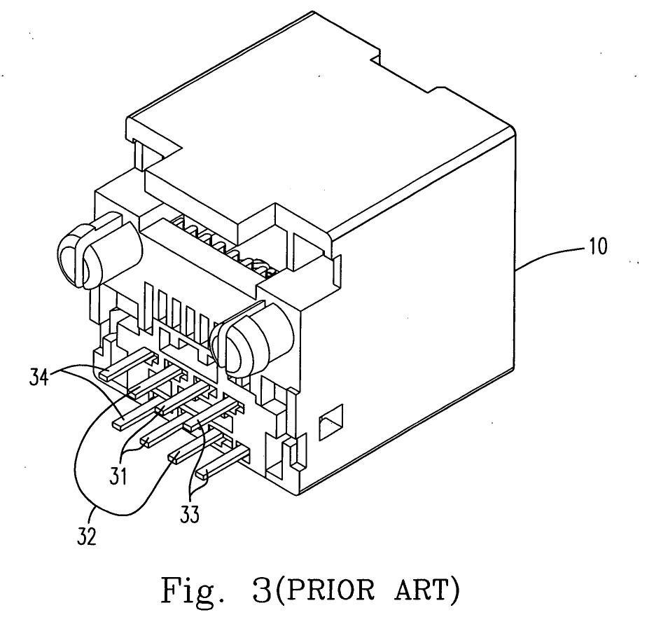

FIG. 4 is a stereo perspective view illustrating a plug for a PCB jack according to a first preferred embodiment of the present invention;

FIG. 5 is an exploded view showing the PCB jack according to the first preferred embodiment of the present invention;

FIG. 6 is stereo perspective view showing the first wires and the second wires of FIG. 5 in detail;

FIG. 7 is a stereo perspective view showing the configuration of FIG. 5;

FIG. 8 is a stereo perspective view showing a printed wire board having the PCB jack of FIG. 5 configured theron;

FIG. 9 is a stereo perspective view showing the PCB jack, the first conducting piece and the second conducting piece of FIG. 7 in greater detail; and

FIG. 10 a stereo perspective view showing the PCB jack of FIG. 7 with the metal wire holder.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

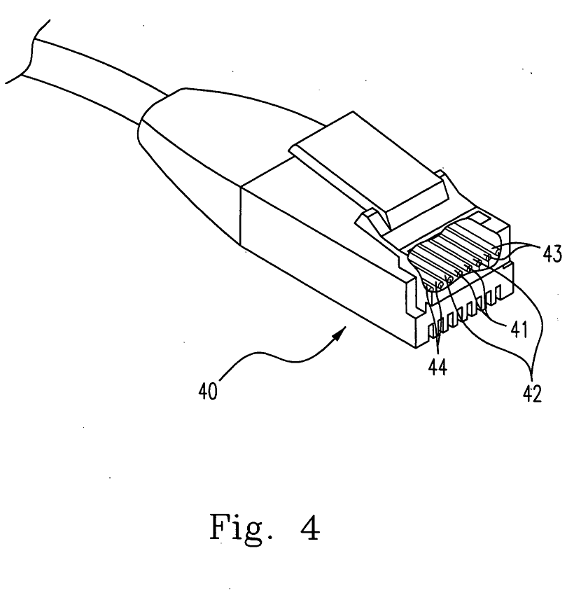

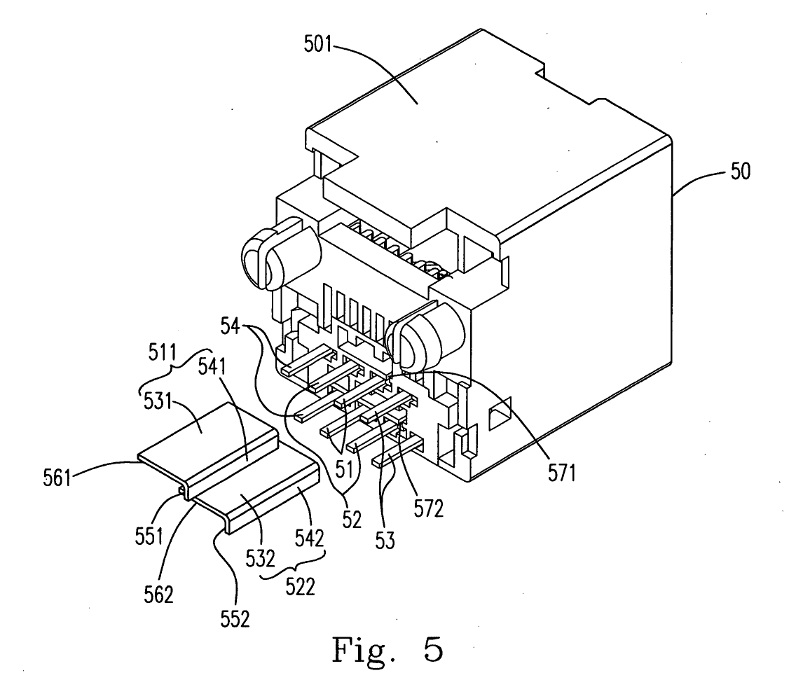

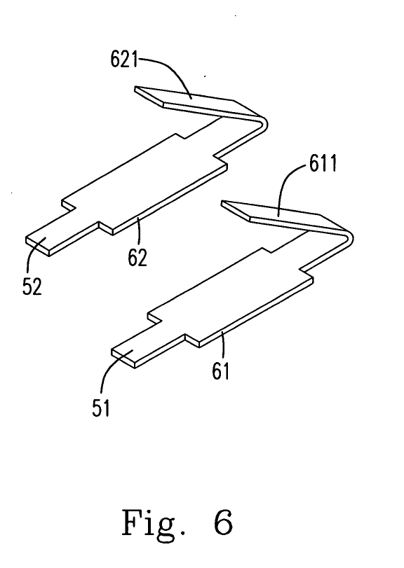

Please refer to FIGS. 4-6 for all the description below. As shown in FIG. 5, the PCB jack 50 according to the first preferred embodiment of the present invention is designed to eliminate the electromagnetic interference generated therein. the PCB jack 50 includes the body 501, first wires 51 settled therein to deliver the first signal, second wires 52 settled therein to deliver the second signal, the first conducting piece 511 and the second conducting piece 522. The first wire 51 and the second wire 52 are illustrated in greater detail in FIG. 6. As shown in FIG. 6, the first conducting piece 511 contacted to the wider portion 61 of the upper first wire 51 is used to avoid the generation of a cross take while the first signals are transmitted. Similarly, the wider portion 62 of the lower second wire 52 is connected to the second conducting piece 522, which is used for eliminating the cross talk while the second signals are transmitted.

The endpoints 611 on each of the first wires 51 of the PCB jack 50 are connected to the blue wires 41 (as shown in FIG. 4) of the network plug respectively. The first conducting piece 511, which is an L-shaped copper sheet, is composed of the capacitor area 531 and the connecting area 541. The wider portion 61 of the upper first wire 51 is designed to connect to this connecting area 541 of the conducting piece 531. Moreover, the extension portion 561 of the capacitor 531 is set up to eliminate the cross talk generated by transmitting of the first signals. Also, the cross talk generated by transmitting of the second signals could be accordingly eliminated thereby. The endpoints 621 on each of the second wires 52 of the PCB jack 50 are connected to the green wires 42 (as shown in FIG. 4) of the network plug respectively. The second conducting piece 522, which is an L-shaped copper sheet, is composed of the second capacitor area 532 and the connecting area 542. Moreover, the second connecting area 542 of the second conducting piece 522 is connected to the wider portion 62 of the lower second wires 52, as that the second cross talk is suppressed by the extension portion 562 of the second capacitor area 532.

Furthermore, the PCB jack 50 includes the third wires 53 and fourth wires 54, wherein the third wires 53 and the fourth wires 54 are respectively connected to the orange wires 43 and brown wires 44 of the network plug shown in FIG. 4 for transmitting the third signals and the fourth signals.

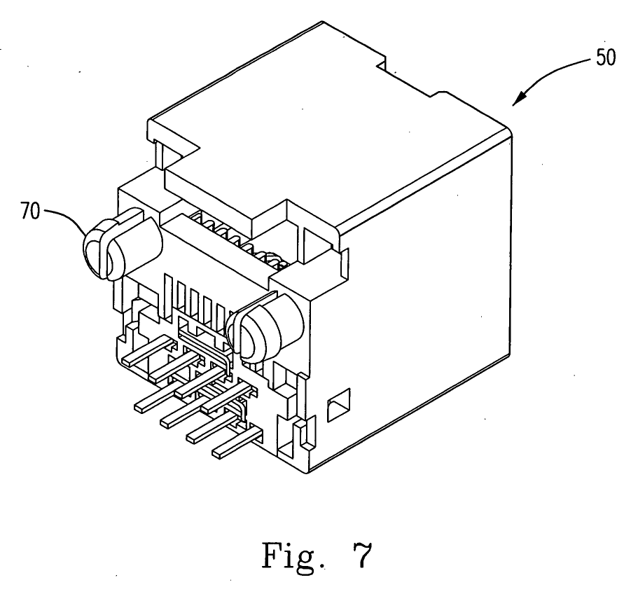

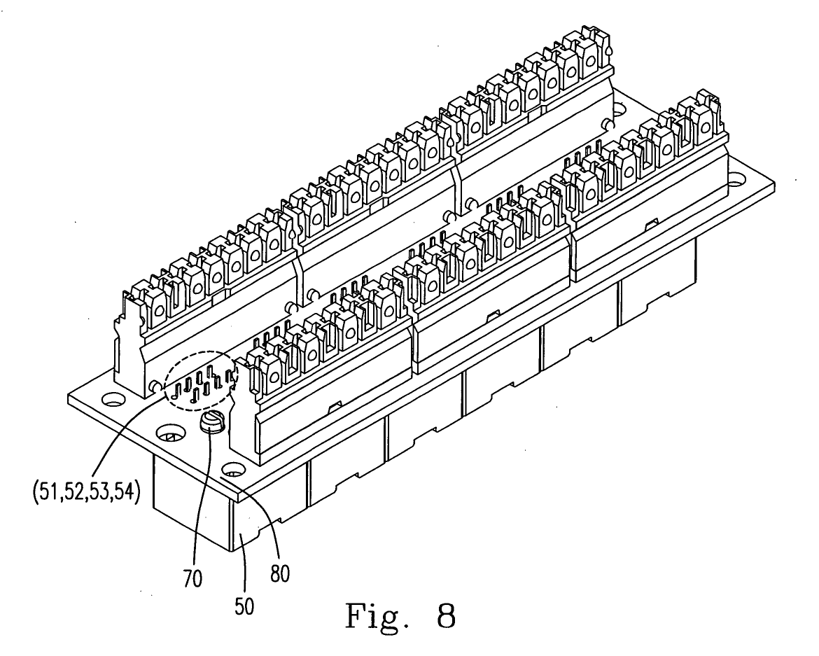

Please refer to FIG. 7 and FIG. 8 for illustrating the PCB jack according to the first preferred embodiment of the present invention and a printed circuit board therewith. The PCB jack 50 showed in FIG. 7 is formed by all the components described above. The PCB jack 50 shown in FIG. 7 further has two tenons 70 for being connected to the printed circuit board 80.

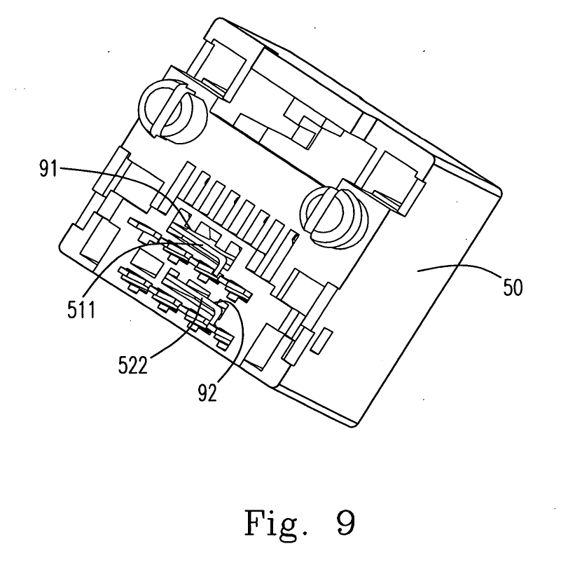

Please refer to FIG. 5 and FIG. 9 for illustrating the engagement of the conducing pieces and the PCB jack according to the first preferred embodiment of the present invention. The body of the PCB jack 50 further includes the first slot 571 for the first connecting piece 511 being placed therein, and the second slot 572 for the second conducting area 542 and second connecting piece 522. The PCB jack 50 showed in FIG. 9 is formed by all the components described above. Furthermore, the PCB jack 50 also includes the first prop 91 and second prop 92 for propping the first conducting piece 511 and the second conducting piece 522.

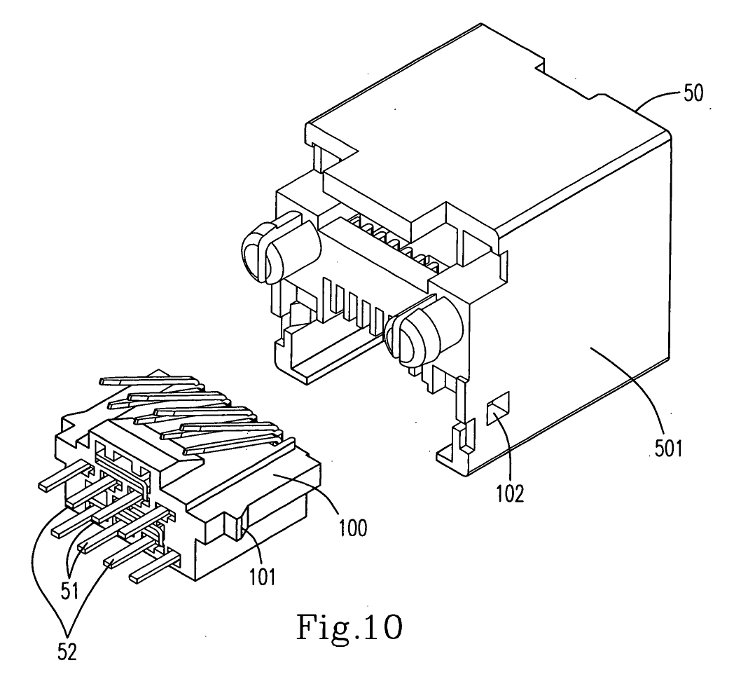

Please refer to FIG. 10 for illustrating the engagement among the wires, the wire holder and the PCB jack according to the first preferred embodiment of the present invention. The PCB jack 50 showed in FIG. 10 is formed by all the components described above. The first wires 51 and the second wires 52 are located inside the metal wire holder 100. The metal wire holder 100 has one tenon 101 thereon for being connected with the slot 102 of the jack body 501.

The second preferred embodiment according to the present invention would be described as follows. In which, for simplifying the descriptions, the drawings for the second embodiment are omitted herein. FIGS. 4-6 are still applied for illustrating the second preferred embodiment.

The PCB jack 50 according to the second preferred embodiment includes the following portions. The jack body 501 is for the network plug 40 to be plugged in. The first wires 51 are set up inside the jack body 501 for delivering the first signal, wherein each of the first wires 51 include the wider portion 61. The first conducting piece 511 is connected to the wider portion 61 of the first wire 51 for eliminating the cross talk of the first signal. The second wires 52 are set up inside the jack body 501 for delivering the second signal, wherein each of the first wires 52 include the wider portion 62. The second conducting piece 522 is connected to the wider portion 62 of the second wire 52 for eliminating the cross talk of the second signal. The other detailed components included in the PCB jack 50 of the second preferred embodiment are the same as that in the PCB jack 50 of the first preferred embodiment. The only difference therebetween is that the second conducting piece 522 is not necessary in the second one, such as the condition of using only one single PCB jack.

The third preferred embodiment according to the present invention would be described as follows. In which, for simplifying the descriptions, the drawings for the third embodiment are omitted herein. FIGS. 5-6 are still applied illustrating the third preferred embodiment.

The PCB jack 50 according to the third preferred embodiment includes the following portions. The first wires 51 with the wider portion 61 of the PCB jack 50 is used for delivering the first signal. The first conducting piece 511 of the PCB jack 50 is connected to the wider portion 61 of the first wires 51 for eliminate the cross talk of the first signals. The second wires 52 with the wider portion 62 of the PCB jack 50 is used for delivering the second signals. The second conducting piece 522 of the PCB jack 50 is connected to the wider portion 62 of the second wires 52 for eliminating the cross talk of the second signals. The other detailed components included in the PCB jack 50 of the third preferred embodiment are the same as that in the PCB jack 50 of the first preferred embodiment. The only difference therebetween is that the PCB jack 50 is not necessary include a jack body. That is to say, the components of the PCB jack 50 are not limited to be included inside a jack body.

To sum up the above, two improved conducting pieces, which are connected separately to the first wires and the second wires are provided by the present invention. The cross talk generated by the signal transmission from these two signals of the two wires are efficiently eliminated thereby. Hence, the present invention not only has the novelty and progressiveness, but also has an industry utility

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A PCB jack for eliminating an electromagnetic interference formed therein comprising:
a jack body for being connected to a plug;
a first wire configured inside said jack body and having a first portion for transmitting a first signal;
a second wire configured inside said jack body and having a second portion for transmitting a second signal;
a first conducting piece connected to said first portion of said first wire; and
a second conducting piece connected to said second portion of said second wire,
wherein said electromagnetic interference formed between said first wire and said second wire is eliminated.

2. The PCB jack according to claim 1, wherein said first wire has a first engaging endpoint for being electrically connected to a blue wire of said plug, and said first conducting piece is an L-shaped copper sheet having a first capacitor area and a first connecting area.

3. The PCB jack according to claim 2, wherein said first connecting area of said first conducting piece has a first connecting surface for being connected to said first portion of said first wire, and said first capacitor area has a first extending surface for eliminating said electromagnetic interference.

4. The PCB jack according to claim 1, wherein said second wire has a second engaging endpoint for being electrically connected to a green wire of said plug, and said second conducting piece is an L-shaped copper sheet having a second capacitor area and a second connecting area.

5. The PCB jack according to claim 4, wherein said second connecting area of said second conducting piece has a second connecting surface for being connected to said second portion of said second wire, and said second capacitor area has a second extending surface for eliminating said electromagnetic interference.

6. The PCB jack according to claim 1 further comprising a third and a fourth wires for being connected to an orange and a brown wires of said plug for transmitting a third and a fourth signals respectively.

7. A PCB jack comprising:
a jack body for being connected to a plug;
a first wire configured inside said jack body for transmitting a first signal; and
a first conducting piece connected to said first wire for eliminating a first cross talk generated upon transmitting said first signal.

8. The PCB jack according to claim 7 being used for eliminating an electromagnetic interference formed therein, wherein said first wire has a first portion, further comprising a second wire configured inside said jack body, wherein said second wire has a second portion for transmitting a second signal, and further comprising a second conducting piece connected to said second portion of said second wire for eliminating a second cross talk generated upon transmitting said second signal.

9. The PCB jack according to claim 7, wherein said first wire has a first engaging endpoint for being electrically connected to a blue wire of said plug, and said first conducting piece is an L-shaped copper sheet having a first capacitor area and a first connecting area.

10. The PCB jack according to claim 9, wherein said first connecting area of said first conducting piece has a first connecting surface for being connected to said first portion of said first wire, and said first capacitor area has a first extending surface for eliminating said first cross talk.

11. The PCB jack according to claim 7, wherein said second wire has a second engaging endpoint for being electrically connected to a green wire of said plug, and said second conducting piece is an L-shaped copper sheet having a second capacitor area and a second connecting area.

12. The PCB jack according to claim 11, wherein said second connecting area of said second conducting piece has a second connecting surface for being connected to said second portion of said second wire, and said second capacitor area has a second extending surface for eliminating said second cross talk.

13. The PCB jack according to claim 7 further comprising a third and a fourth wires for being connected to an orange and a brown wires of said plug for transmitting a third and a fourth signals respectively.

14. A PCB jack, comprising:
a first wire having a first portion for transmitting a first signal;
a second wire having a second portion for transmitting a second signal;
a first conducting piece connected to said first portion of said first wire for eliminating a first cross talk generated upon transmitting said first signal; and
a second conducting piece connected to said second portion of said second wire for eliminating a second cross talk generated upon transmitting said second signal.

15. The PCB jack according to claim 14 being used for eliminating an electromagnetic interference formed therein, and further comprising a jack body for being connected to a plug, wherein said first wire and said second wire are configured inside said jack body

16. The PCB jack according to claim 15, wherein said first wire has a first engaging endpoint for being electrically connected to a blue wire of said plug, and said first conducting piece is an L-shaped copper sheet having a first capacitor area and a first connecting area.

17. The PCB jack according to claim 16, wherein said first connecting area of said first conducting piece has a first connecting surface for being connected to said first portion of said first wire, and said first capacitor area has a first extending surface for eliminating said first cross talk.

18. The PCB jack according to claim 17, wherein said jack body has a first and a second slots for respectively containing therein said first connecting area of said first conducting piece and said second connecting area of said second conducting piece

19. The PCB jack according to claim 15, wherein said jack body has a first and a second props for propping said first and said second conducting piece.

20. The PCB jack according to claim 15, wherein said first and said second wires are configured inside a holder, wherein said holder has a protruding tenon for engaging a third slot of said jack body.
